(19) United States
(12) Patent Application Publication
(10) Pub. No.: US 2004/0205174 A1
(43) Pub. Date: Oct. 14, 2004

(54) XML driven WebDAV unit test framework

(76) Inventors: Joseph J. Snyder, Shamon, NJ (US); Jason Kinner, Marlton, NJ (US); Richard Friedman, Cherry Hill, NJ (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/371,286

(22) Filed: Feb. 21, 2003

(51) Int. Cl. G06F 15/173; G06F 15/16; G09G 5/00

(52) U.S. Cl. 709/223; 709/201; 345/760

(57) ABSTRACT

A method of unit testing of a component selected from the group consisting of applications and server implementations for response relative to the WebDAV protocol is provided. The method comprises providing a WebDAV unit testing framework and providing a WebDAV compliance utility containing a suite of unit tests. The method further comprises applying a unit test from the suite to the component under test via the unit-testing framework, and comparing the response of the component to the applied unit test with a standard unit test response stored in memory.

### CROSS-REFERENCE TO RELATED APPLICATIONS

This Application is related to co-pending, concurrently filed, and commonly assigned U.S. patent applications Ser. No. [Attorney Docket No. 100203190-1] entitled “XML DRIVEN WEBDAV UNIT TEST FRAMEWORK,” [Attorney Docket No. 100202441-1] entitled “WEBDAV URL CONNECTION,” and Ser. No. [Attorney Docket No. 100202438-1] entitled “WEBDAV UNIT TEST FRAMEWORK”; the disclosures of all of which are hereby incorporated herein by reference.

### BACKGROUND

Rich media is an Internet industry term for a Web page advertisement that uses advanced technology such as streaming video, downloaded applets (programs) that interact instantly with the user, and advertisements that change appearance and/or content when the user's cursor passes over them. The foundation of rich media architecture is the storage layer for digital assets, e.g., any digitally stored information. Providing an abstraction to the digital assets is the key to developing rich media-based applications and services. Defining this layer has the same importance as defining a common language and Application Programming Interfaces (APIs) for accessing traditional relational database systems. The storage layer comprises the asset, the metadata about the asset, and the structure to store this information. The storage layer has to provide expected features such as insert, update, delete and query.

Today, where and how to store digital assets, metadata, and the associations between them is a complex problem. Different applications can have vastly different requirements for storage. It is generally desirable to provide an abstract storage mechanism that will allow for heterogeneous storage for any or all of the above storage layer objects. Web-based Distributed Authoring and Versioning (WebDAV) is a protocol defined by the IETF RFC 2518 and is an extension of the HTTP protocol (RFC 2616). The WebDAV specification addresses the storage of all three types of object, and is currently in use in network storage solutions and web servers, as well as being supported in many authoring tools and in most operating systems.

Content management solutions, including editing functions such as read, write, delete, move, copy, etc., are a good fit for the storage requirements as well, and many already support WebDAV. In fact, WebDAV is divided into three separate specifications, each of which addresses particular storage operations: WebDAV (Web Distributed Authoring and Versioning), DASL (Searching and Locating), and Delta-V (Versioning). The WebDAV platform can also make it easier to add WebDAV capabilities to an existing Content Management System (CMS), in order to promote WcbDAV technology.

### SUMMARY

In accordance with a first embodiment disclosed herein, a system operable to support Web-based Distributed Authoring and Versioning (WebDAV) protocol is provided. This system comprises a plurality of applications and server implementations, and a WebDAV-compliant connector operable to access WebDAV-compliant servers as enterprise resources, the connector conforming to a Java™ Connector Architecture (JCA) specification. The system further comprises a resource adapter application programming interface (API) operable to

In accordance with another embodiment disclosed herein, a method that conforms to a Java™ Connector Architecture (JCA) specification for accessing WebDAV-compliant servers as enterprise resources is provided. The method comprises providing a WebDAV-compliant connector communicating with a multilayer resource adapter API, and creating a SAX-based processing pipeline. The method further comprises processing property values using the processing pipeline, using a MultiStatus Response Record to map a resource URL to a set of properties, and implementing accessor methods for marshaling property values to and from an XML format. The method further comprises using the processed property values to enable transmitting WebDAV messages between a client and a server.

In accordance with another embodiment disclosed herein, a system operable to support Web-based Distributed Authoring and Versioning (WebDAV) protocol is provided. The system comprises means for providing a WebDAV-compliant connector communicating with a multilayer resource adapter API. The system further comprises means for creating a SAX-based processing pipeline and means for processing property values using the processing pipeline. The system further comprises means for using a MultiStatus Response Record to map a resource URL to a set of properties, means for implementing accessor methods for marshaling property values to and from an XML format, and means for using the processed property values to enable transmitting WebDAV messages between a client and a server.

In accordance with another embodiment disclosed herein, computer-executable software code stored to a computer-readable medium is provided. The computer-executable software code comprises code for processing property values using a processing pipeline, code for using a MultiStatus Response Record to map a resource URL to a set of properties, code for implementing accessor methods for marshaling property values to and from an XML format, and code for using the processed property values to enable transmitting WebDAV compliant messages between a client and a server.

### BRIEF DESCRIPTION OF THE DRAWING

FIG. 1 is a block diagram illustrating an overview of WebDAV system architecture according to the present embodiments; and

FIG. 2 is a more detailed schematic block diagram illustrating the relationships between WebDAV Unit framework, HTTP Unit, WebDAV Compliance utility and WebDAV server within the WebDAV system architecture.

FIG. 3 is a flow diagram depicting the deployment of WebDAV URL Connection using WebDAV Protocol Handler, according to the present embodiments.

FIG. 4 is a simplified schematic diagram representing WebDAV Resource Adapter;

FIG. 5 is a schematic block diagram representing the relationship between WebDAV Resource Adapter and base JCA architecture; and

FIG. 6 is a block diagram schematically representing a Value Formatter, in accordance with the present embodiments.

### DETAILED DESCRIPTION

A system and method access WebDAV-compliant servers as enterprise resources using a WebDAV-compliant connector that conforms to versions of the Java™ Connector Architecture (JCA) specification, that communicates with a multilayer resource adapter application programming interface (API), which processes property values using well-formed eXtensible Markup Language (XML) via a Simple API for XML (SAX)-based processing pipeline API. The SAX-based processing pipeline API uses a MultiStatus Response Record to map a resource URL to a set of properties and implements accessor methods for marshaling property values to and from an XML format. The processed property values enable transmitting WebDAV messages between a client and WebDAV-compliant servers.

In various embodiments, the architecture of the resource adapter API includes an EnterpriseJavaBeans™ (EJB) layer, a servlet layer, and/or a JCA layer. In some embodiments, the WebDAV-compliant connector accesses WebDAV-compliant servers from a Java™ version 2 Enterprise Edition (J2EE) application and/or from a WebDAV-compliant browser. In some embodiments the SAX-based processing pipeline is created using an AbstractValueFormatter WebDAV class, thereby extending a SAX DefaultHandler class. In some embodiments creating the SAX-based processing pipeline includes overriding XML parsing methods in which property values are encoded in a WebDAV-compliant server and reporting and storing errors either as WebDAVException(s) or as HTTPException(s). In some embodiments, the resource adapter API encodes WebDAV property values.

The resource adapter API provides advantages including lock management, connection management, pooling, and support of a Distributed Authoring Searching and Locating (DASL) protocol, that are not available in the prior art.

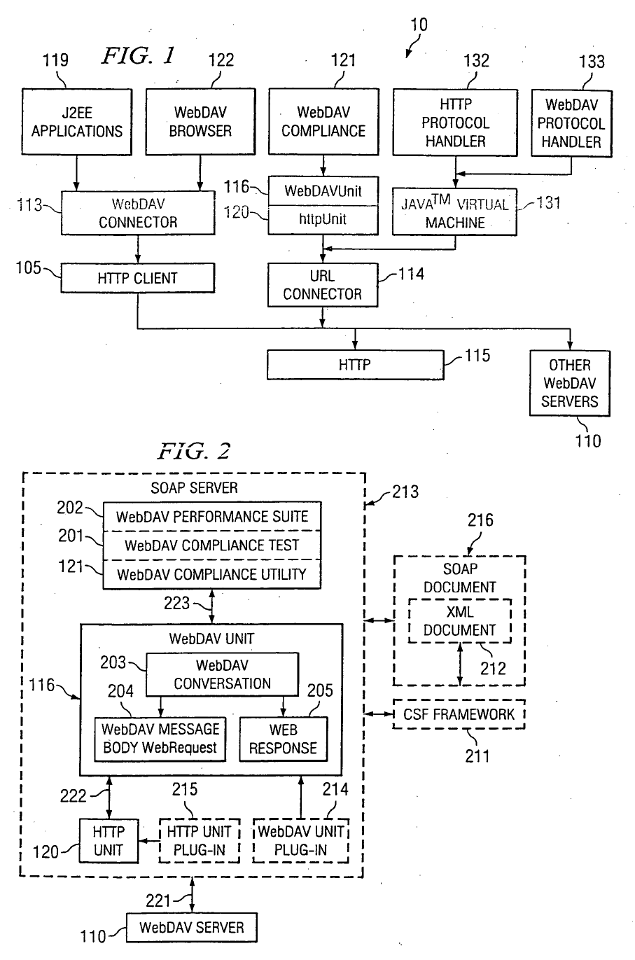

The storage abstraction architecture has produced many components which create both the abstraction for the storage system and a usable storage infrastructure upon which systems are created. While much of the storage abstraction is viewed as a server side layer, there are many layers of connectivity into such a layer. FIG. 1 is a partial overview block diagram illustrating various components of WebDAV system architecture 10, which includes mechanisms for connecting and testing such systems, according to the present embodiments.

WebDAV system architecture 10 comprises various components that are made available within an installation. Each component, whether for example a web application or a library, has its own description of usage and configuration.

Architecture 10 further includes WebDAV Java™ Connector Architecture (JCA) connector 113, which provides a standard client API for connecting into WebDAV server 110. JCA connector 113 utilizes HTTP client 105 for HTTP connectivity. HTTP client 105, which is outside the scope of the present disclosures, is adapted from the open source HTTP client efforts within the Apache Jakarta Commons project. The home page for Commons HTTP client is HTTP://jakarta.apache.org/commons/HTTPclient/. HTTP URL connector 114, which extends the common Java™ Development Kit (JDK) version, is provided to upgrade prior art HTTP URL connector 115, which does not presently support the needed WebDAV methods.

It is further advantageous in WebDAV architecture 10 to access any WebDAV server 110 and/or any non-relational data sources from a WebDAV browser, for example WebDAV browser 122, and/or from a J2EE application, for example J2EE application 119, via a WebDAV-compliant connector that conforms to Java™ Connector Architecture (JCA), depicted as WebDAV connector 113.

WebDAV Protocol Handler 133 is a low-level component that allows an application to have a raw WebDAV conversation with a WebDAV server, for example WebDAV server 110. According to some embodiments, JAVA™ Virtual Machine (JVM) 131 is configured to use WebDAV Protocol Handler 133 instead of traditional HTTP protocol handler 132 for HTTP requests by setting the system property java.protocol.handler.pkgs to com.hp.mw.richmedia.webdav.protocol. Any subsequent HTTP URL requests are then resolved using WebDAV Protocol Handler 133. After configuring WebDAV Protocol Handler 133 for use on HTTP connections, WebDAV Protocol Handler 133 utilizes the URL openConnection mechanism for a subsequent HTTP URL request. When JAVA™ Virtual Machine (JVM) 131 is configured to use traditional HTTP protocol handler 132 for HTTP requests, however, HTTP URL requests are not WebDAV compliant.

WebDAV Unit 116 was built as an adaptation of traditional HTTP Unit 120 web testing framework. WebDAV Unit 116 aims to simplify the creation of WebDAV unit tests. WebDAV Unit 116 is a unit testing framework extending open source HTTP Unit framework 120, allowing unit testing of WebDAV application and server implementations employing WebDAV Compliance utility 121. In the context of the present disclosure, a unit test is a test of one application to see if remediation efforts were successful. The unit test does not generally test how well the tested application will work in an interaction with other applications. Thus, a unit test is an invocation that tests a definable and confined unit. For example, testing a WebDAV method is a unit test. Advantageously, WebDAV Unit 116 allows WebDAV servers 110 to be tested via a simple API and allows automated testing of WebDAV servers 110. A test suite is created to invoke test operations against a WebDAV server, simulating what real users might or might not do in an environment in which a user could invoke many links and directions.

FIG. 2 is a more detailed schematic block diagram illustrating the relationships between WebDAV Unit framework 116, HTTP Unit framework 120, WebDAV Compliance utility 121, and WebDAV server 110 through links 221, 222, and 223 within WebDAV system architecture 10 in accordance with one embodiment. Links 221, 222, and 223 can be although need not be physical links, and can be any sort of hardware or software communication links in a network. In accordance with the present embodiment, WebDAV Unit 116 comprises three main objects, namely WebDAVConversation 203, WebDAVMessageBodyWebRequest 204, and WebResponse 205. WebDAVConversation 203 holds the context for a series of WebDAV requests. It manages cookies used to maintain session context, computes relative URLs and generally emulates client behavior needed to build an automated test of a WebDAV server. WebDAVMessageBodyWebRequest 204 class is the base class for all WebDAV requests. It holds the contents of a request including the WebDAV method, header information, and the body of the request. WebResponse 205 class represents the response of a standard HTTP or WebDAV request. It contains response headers as well as response data.

In some embodiments, unit testing is run in a service oriented architecture, for example Core Services Framework (CSF) 211. CSF 211 is a services-based container in WebDAV architecture 10, which allows disparate services to interact with one another. Applications are built by deploying the services needed by the application. In some embodiments, WebDAV Unit 116 is implemented as a CSF service. Advantageously, this allows WebDAV Unit 116 to be controlled by CSF framework 211 and allows easy integration with applications that require it. Similarly, in some embodiments HTTP Unit framework 120 is implemented as a CSF service, such that HTTP Unit 120 is controlled advantageously by CSF framework 211, allowing easy integration with applications that require it.

WebDAV Compliance utility 121 built upon WebDAV Unit is the beginning of a test suite, for example WebDAV Compliance Suite 201 and/or WebDAV Performance Suite 202, which are each a set of WebDAV unit tests (a suite) that provide information about their respective topic. For example, a WebDAV Compliance Test is a unit test used to confirm if a WebDAV server, for example WebDAV server 110, is compliant with the WebDAV standard. WebDAV Compliance Suite 201 provides a complete set of tests that would validate if a WebDAV server as complying with the WebDAV specification (RFC2518). Similarly, a WebDAV Performance test is a unit test used to guarantee that a WebDAV server delivers a specific performance, for example a specific response time, in response to the specific unit test. A WebDAV Performance Test measures a product's efficiency or performance while it is running, and is thus more subjective than a WebDAV compliance test. WebDAV Performance Suite 202 comprises a group of tests that measure a product's performance in different WebDAV contexts.

In some embodiments, an eXtensible Markup Language (XML) document 212 can be used to drive and define the tests that are run by WebDAV Unit 116. Advantageously, by using XML to define the tests, no code needs to be written to add new tests or to modify existing tests, whereas traditional methods require the writing of code for each WebDAV Unit test that is performed. This greatly reduces the programming sophistication required of the person routinely writing or modifying the tests.

In some embodiments, WebDAV Compliance Test 201 and/or WebDAV Performance Suite 202 is implemented as a web service, advantageously allowing WebDAV Compliance Test 201 to be accessed and used like other web services. In some embodiments, WebDAV Performance Suite 202 is offered as a web service via Simple Object Access Protocol (SOAP), an existing technology that is used to access web services. Defining a SOAP envelope 213 for WebDAV Performance Suite 202 allows it to be accessed via SOAP.

To drive WebDAV Compliance Test 201 and WebDAV Performance Suite 202 unit tests as XML documents, thereby exposing WebDAV test suites 201, 202 (or WebDAV unit in general) as a web service, XML Document 212 is wrapped in a SOAP Envelope, for example SOAP Document 216. This is accomplished in accordance with conventional practice by embedding XML Document 212 in SOAP Document 216. Similarly, XML driven WebDAV Unit 116 is embedded in SOAP server 213 and connected via WebDAV Unit plug-in mechanism 214 provided by SOAP server 213. In some embodiments, SOAP server 213 alternatively or additionally wraps HTTP Unit 120, thereby allowing HTTP unit testing to be driven as a web service by XML document 212.

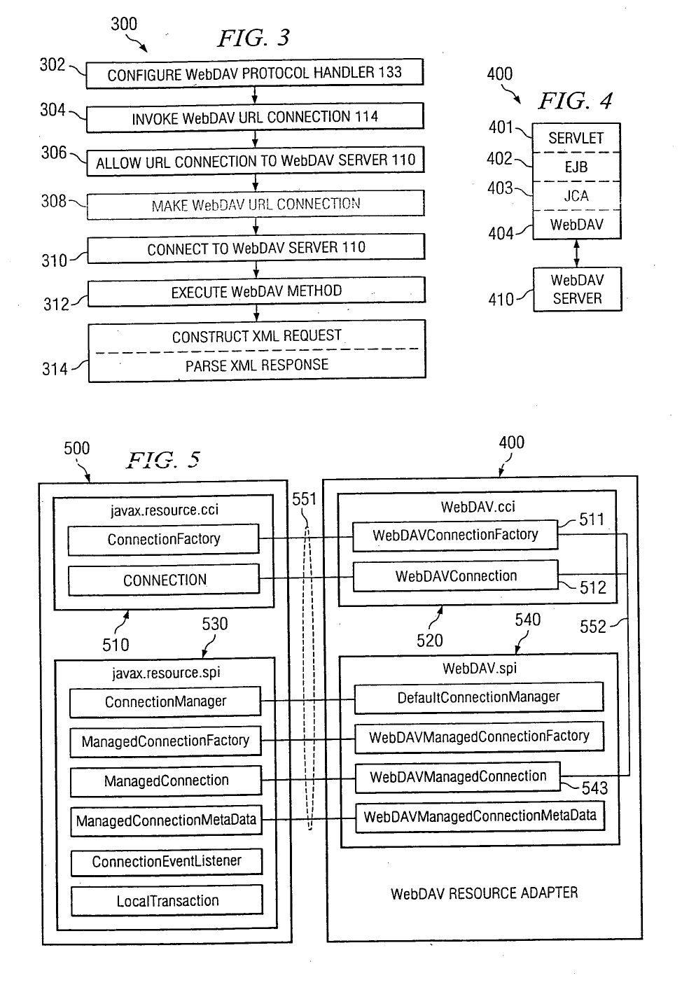

Referring again to FIG. 1, WebDAV Protocol Handler 133 is a low-level component that allows an application to have a raw WebDAV conversation with a server 110. In a raw WebDAV conversation, a protocol handler and connection are mechanisms which assist in creating a connection with a WebDAV server, e.g., server 110, and then conversing with the WebDAV server via its known protocol. FIG. 3 is a flow diagram 300 depicting the deployment of WebDAV URL Connection 114 using WebDAV Protocol Handler 133, according to some embodiments. At step 302, JAVA™ Virtual Machine (JVM) 131 is configured to use WebDAV Protocol Handler 133 (instead of traditional HTTP protocol handler 132) for HTTP requests by setting the system property java.protocol.handler.pkgs to WebDAV Protocol Handler, for example Protocol Handler 133. Any subsequent HTTP URL requests are then resolved using WebDAV Protocol Handler 133. After configuring WebDAV Protocol Handler 133 for use on HTTP connections, WebDAV Protocol Handler 133 utilizes the URL openConnection( ) mechanism for a subsequent HTTP URL request.

To support WebDAV-specific methods over HTTP, at step 304 WebDAV Protocol Handler 133 invokes WebDAV URL Connection 114, which at step 306 allows URL connections to be made to WebDAV servers 110 using the conventional URL.getConnection( ) API, where the API acronym stands for Application Programming Interface. When WebDAV URL Connection 114 is invoked using openConnection( ) method on a URL, any HTTP URL request will result in a WebDAV URL Connection 114 being made at step 308 instead of the conventional HTTP URL Connection. WebDAV URL Connection 114 provides a URL connection object allowing clients at step 310 to connect to WebDAV servers 110. It also allows clients using the connection at step 312 to execute WebDAV methods. In some embodiments, at step 314 an application using WebDAV Protocol Handler 133 advantageously constructs valid XML requests and parses XML responses from WebDAV Server 110.

This mechanism allows WebDAV-specific methods to be transported and executed over the HTTP channel. No other higher-level handling is typically provided. Although commercial manufacturers, for example Sun Microsystems, provide prior art HTTP URL Connections, these implementations do not allow WebDAV methods to be executed.

Referring again to FIG. 1, it is advantageous in WebDAV architecture 10 to access any WebDAV server 110 and/or any non-relational data sources from a WebDAV browser, for example WebDAV browser 122, and/or from a J2EE application, for example J2EE application 119, via a WebDAV-compliant connector that conforms to Java™ Connector Architecture (JCA), version 1.0, depicted as WebDAV connector 113. WebDAV-compliant connectors that conform other versions of the JCA specifications are straightforward variations of WebDAV connector 113 described herein, and as such are understood to fall within the scope of the present disclosures. FIG. 4 is a simplified schematic diagram representing WebDAV Resource Adapter 400, a software component that conforms to Java™ Connector Architecture (JCA), version 1.0, and accesses WebDAV-compliant servers as enterprise resources. JCA layer 403 provides a standard API containing Servlet layer 401 and Enterprise JavaBeans (EJB) layer 402 to access non-relational data sources (non-RDBMS) from a J2EE application.

Enterprise JavaBeans (EJB) is a well-known architecture for setting up program components, written in the Java programming language, that run in the server parts of a computer network that uses the client/server model. EJB is built on the JavaBeans technology for distributing program components (which are called Beans, using the coffee metaphor) to clients in a network. EJB offers enterprises the advantage of being able to control change at the server rather than having to update each individual computer with a client whenever a new program component is changed or added. EJB components have the advantage of being reusable in multiple applications. To deploy an EJB Bean or component, it must be part of a specific application, which is called a container. Like all Java-based architectures, EJB can be deployed across all major operating systems, i.e., it is platform independent.

WebDAV Connector layer 404 implements WebDAV Resource Adapter API 400 to connect to any server 410 that implements WebDAV protocol. WebDAV Resource Adapter 400 advantageously adds connection management/pooling (part of JCA) to the WebDAV physical connection, provides lock management, and also supports the Distributed Authoring Searching and Locating protocol (DASL), currently an Internet draft protocol.

Much of the architecture of WebDAV Resource Adapter 400 is defined by the JCA specification. FIG. 5 is a schematic block diagram representing the relationship between WebDAV Resource Adapter 400 and base JCA architecture 500. Overall architecture is divided between JCA CCI (Client Connector Interface) 510, 520 and SPI (Service Provider Interface) 530, 540 implementation classes. CCI 520 implements the API that a J2EE developer uses to interact with WebDAV Connector 404. WebDAV Resource Adapter 400 follows CCI 520 and extends the base concepts of Connection, Record, InteractionSpec, and Interaction, as defined by CCI 520. SPI 540 defines a physical connection layer to WebDAV server 410 and is derived from SPI-specified classes such as ManagedConnection 543. Dashed lines 551 indicate implementation relationships, whereas solid lines 552 indicate dependencies among implementation classes.

As defined in protocol specification IETF RFC 2518, WebDAV protocol requires an extensive amount of XML processing. Messages between client and server are formatted using XML, and properties are stored using XML namespaces and element names to uniquely identify them. The WebDAV protocol includes a restriction that a property can have only one value; but it allows that value to be encoded using well-formed XML.

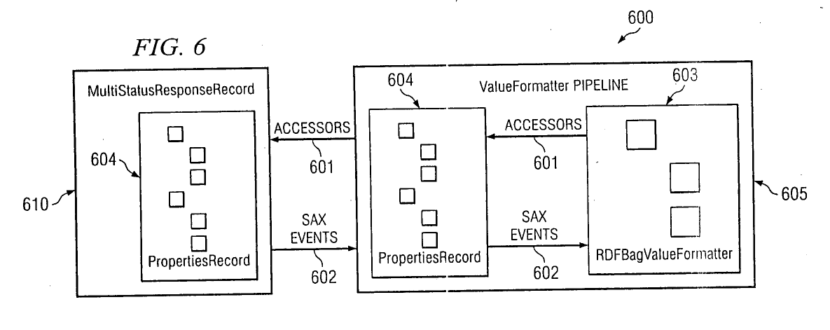

WebDAV Resource Adapter 400 takes advantage of these properties through a Simple API for XML (SAX)-based processing pipeline architecture called ValueFormatter. FIG. 6 is a block diagram schematically representing ValueFormatter pipeline architecture 600. ValueFormatter architecture 600 includes ValueFormatter pipeline 605 containing ValueFormatter 603, for example RDFBagValueFormatter. In the WebDAV protocol, a property with a single name but multiple values must be supplied in XML. Each property value is represented by a properties record, for example PropertiesRecord 604. Multiple PropertiesRecords 604 are stored in MultiStatusResponseRecord 610. ValueFormatter architecture 600 is designed to allow extensibility in the XML formats that are used to encode multiple values. For example, a system could be defined with a single rigid definition of the appearance of an XML document, such that the system could then process only that type of XML document. Extensibility would, however, allow for multiple XML definitions to be used and allow different ValueFormatters to process that information.

Illustratively, the property “children” can be described with different values for three children a, b. c in alternative formats, for example:

<CHILDREN><CHILD name=“a”/><CHILD name=“b”/><CHILD name=“c”/></CHILDREN>; or

<CHILDREN>a,b,c </CHILDREN>

Both formats are valid XML documents, but their translation back into properties would use very different programmatic methods. ValueFormatter architecture 600 allows different formats. How the XML is interpreted is the responsibility of an implementation of ValueFormatter 603 as defined in that specific implementation. There would be a different ValueFormatter 603 for each multi-value property.

ValueFormatter 603 is also used when reading the WebDAV lockdiscovery property, which has a specific XML encoding, when lock interactions are executed. Creating ValueFormatter 603 includes first implementing an AbstractValueFormatter class, which extends the SAX DefaultHandler class, overriding the XML methods that are required to parse the XML format in which property values are encoded in WebDAV server 410, and then implementing accessor methods 601 and SAX events 602 that marshal property values to and from the XML format. An accessor method is a method that accesses a given property, for example for a read or write function. Accessors for a read function could for example include getChild( ), getName( ), getSocialSecurity( ), whereas a write method could for example be setName(String name).

MultiStatusResponseRecord 610 represents a multistatus response from an appropriate WebDAV method. MultiStatusResponseRecord 610 and PropertiesRecord 604 each contain a key that maps to a value. An “href” attribute on PropertiesRecord 604 is the key in MultiStatusResponseRecord 610 that maps to the property value for the property record with that “href” (or relative URL). An example is shown in the table below.

MultiStatusResponseRecord

| Key | Value |
|---|---|
| href=/foo.html | Properties Record |

| | |
|---|---|
| Key | Value |
| DAV:getlastmodified | Feb. 17, 2003 |

| | |
|---|---|
| href=/bar.html | Properties Record |

| | |
|---|---|
| Key | Value |
| DAV:getlastmodified | Feb. 14, 2003 |

A particular ValueFormatter object, for example ValueFormatter 603, is used when MultiStatusResponseRecord 610 is interpreting the XML results from a Multistatus operation. Specifically, SAX events 602 generated during the parsing of the response are propagated through MultiStatusResponseRecord 610 into PropertiesRecord 604, which in turn creates ValueFormatter 603 based on the property (DAV:getlastmodified, for example m the table) that is being read for a given resource (/foo.html or /bar.html, as indicated by the href attribute of MultiStatusResponseRecord 610). ValueFormatter 603 then translates the generated SAX events 602 into value objects (for example calendar dates Feb. 17, 2003, or Feb. 14, 2003), that are stored in the value side of the PropertiesRecord.

Turning again to FIG. 5, WebDAV Resource Adapter 400 is a developer component. Its intended use is as part of a larger application, for example integrating with other Enterprise data sources. Before using WebDAV Resource Adapter 400, an application first establishes a connection to server 410. WebDAV Resource Adapter 400 supports both standalone and managed mechanisms in JCA.

In an application server environment, a resource is configured in Java™ Naming and Directory Interface (JNDI), much like a database. The JNDI lookup on the configured resource returns a WebDAVConnectionFactory 511. Individual WebDAV connections 512 can be created from this Connection Factory. When WebDAVConnection 512 is created, a URL is specified relative to the configured root of WebDAV server 410. This URL represents the virtual root for any WebDAV interaction on the connection. In standalone mode, WebDAVConnectionFactory 511 can be created and used in the usual way, but the full URL to WebDAV server 410 is generally specified when creating a new connection.

Interaction specifications and function names are available to developers working with WebDAV servers through the resource adapter. Examples of each of the following available interaction specifications include:

CollectionIteractionSpec—for performing Make Collection and Delete operations

StreamInteractionSpec—for performing Get, Put, Head, and Post operations

PropertyInteractionSpec—for setting, removing, or updating properties

CopyInteractionSpec—for performing Move and Copy operations

LockInteractionSpec—for performing Lock and unlock operations

SearchInteractionSpec—for performing DASL

Search operations are illustrated by the sample code shown in APPENDIX A below.

Use of these interaction specifications follow the use of the methods in the WebDAV specification. All interaction specifications are implemented using the single interaction class, WebDAVInteraction. Generally, an interaction specification class is created and configured, an argument record is created, if needed, and the interaction is executed. The following sections break down the properties to be set on each interaction specification:

CollectionInteractionSpec

| | |
|---|---|
| FunctionName | MKCOL or DELETE |
| Path | The relative URL to the resource |

Stream InteractionSpec

| | |
|---|---|
| FunctionName | GET, PUT, HEAD or POST |
| Path | The relative URL to the resource |

PropertyInteractionSpec

| | |
|---|---|
| FunctionName | PROPFIND or PROPPATCH |
| Path | The relative URL to the resource |
| QueryType | The type of PROPFIND query to execute |

CopyInteractionSpec

| | |
|---|---|
| FunctionName | COPY or MOVE |
| Path | The relative URL to the resource |
| Depth | The depth (in child collections) to descend on the |
| | operation |

LockInteractionSpec

| | |
|---|---|
| FunctionName | LOCK or UNLOCK |
| Path | The relative URL to the resource |
| Depth | The depth (in child collections) to descend into the |
| | operation |
| LockScope | The scope of the lock, Exclusive or Shared |
| LockTimeout | The timeout of the lock |
| LockOwner | The owner or contact for the lock |

SearchInteractionSpec

| | |
|---|---|
| FunctionName | SEARCH |
| Path | The relative URL to the resource |
| SearchQuery | The XML search, formatted according to a search |
| | schema accepted by the search arbiter at path. |

In some embodiments, each interaction specification must have a function name set (in accordance with the JCA CCI interface standard). In some embodiments, any WebDAV interaction specification must also have a path set (so that the interaction knows what resource to operate upon). Of all of these interaction specifications, the only one that requires an argument Record is the PropertyInteractionSpec. For property interactions, an IndexedRecord or a MappedRecord must be submitted. For an IndexedRecord, the set of WebDAVProperty objects in the record is removed from the resource. A MappedRecord specifies a map from a WebDAVProperty object to a List of values to be set in that property. Setting a property removes any previous values for that property.

For lock interactions, results will automatically be processed by the WebDAVConnection 404. WebDAV connection 404 is persistent and requires some state to be maintained, specifically lock state. WebDAVConnection 404 hides the complexity of managing lock state and will submit any valid lock tokens that were retrieved through a lock interaction back to the server when those resources are accessed. The lock data is also returned as a PropertiesRecord 604, containing the lock information for the newly-locked resource. In accordance with the present disclosure, a detailed implementation of the JCA standard is specified for connecting to WebDAV. Other disclosures for building a bridge that enables the connections are included in co-pending and commonly assigned U.S. patent application Ser. No. [Attorney Docket No. 100203180-1] titled “SYSTEM AND METHOD FOR INVOKING WEBDAV METHODS VIA NON-WEBDAV COMMUNICATION PROTOCOLS,” filed Feb. 17, 2003, co-pending and commonly assigned U.S. patent application Ser. No. [Attorney Docket No. 100203182-1] titled “SYSTEM AND METHOD FOR INVOKING WEBDAV METHODS VIA NON-WEBDAV PROTOCOLS,” filed Feb. 17, 2003, and co-pending and commonly assigned U.S. patent application Ser. No. [Attorney Docket No. 100203178-1] titled “SYSTEM AND METHOD FOR INVOKING WEBDAV METHODS VIA COMPONENT TECHNOLOGIES,” filed Feb. 17, 2003, the disclosures of which are hereby incorporated herein by reference.

Referring again to FIG. 6, any interaction that returns results (other than a lock interaction) will return a MultiStatusResponseRecord 610, which will map a resource URL to a set of properties. Errors are reported as either WebDAVException(s) or as HTTPException(s). A WebDAVException reports the URL as well as any properties that were involved in the resource error. Warnings are reported in the same way, except that the ResourceWarning structure provided by the CCI is used, and the exceptions are stored as linked exceptions instead of being discarded.

Although configuring WebDAV Resource Adapter 400 is application server-specific, below are outlined configuration properties and sample values in a META-INF/ra.xml file of a RAR file. As defined in the JCA specification, Ra.xml is a file that maintains configuration information, whereas RAR is a defined structure for a zip file packaging the components and configuration of a JCA connector.

| Property name | Property description | Example value |
|---|---|---|
| ConnectionURL | The absolute URL to a | http://localhost:91/ |
| | WebDAV-compliant | slide/files |
| | HTTP resource | |
| FormatterConfigURL | The URL that configures | File:/c:/hpmw/hpas/lib/ |
| | the property formatter | formatter-config.xml |
| | (see below). | |

The XML document referred to in FormatterConfigURL is a configuration file for ValueFormatter pipeline 600. A ValueFormatterFactory is configured based on the contents of this file. When a property is to be formatted, the factory is asked to produce a ValueFormatter 600 for the property. If no ValueFormatter is specified in the configuration file, none is returned.

The configuration file contains a root element, value-encodings (with child elements value-encoding). For each value-encoding element, there is a property-match element that specifies either the XML namespace or the namespace and the element name. If the element name is provided, then the format of the property-match element is namespace#name, similar to an Xpointer representation. There is another child element of value-encoding, encoder-class, that specifies an implementation of ValueFormatter that formats that property or namespace. The DAV: namespace is predefined by all instances of ValueFormatterFactory, but those values can be overridden.

APPENDIX A lists sample code showing how to establish a connection to a JNDI WebDAV resource.

Appendix A: Sample Code

NOTE THAT COMMENTS ARE EMBEDDED IN THE CODE USING THE JAVA™ COMMENT STYLE OF ‘//COMMENT’.

The following sample code shows how to establish a connection to a JNDI WebDAV resource.

```
ConnectionSpec spec;
  ConnectionFactory factory;
  WebDAVConnection conn;
  factory = (ConnectionFactory) ctx.lookup ( “java:
  comp/env/webdav/local” );
  spec = new WebDAVConnectionSpec ( “/”, “username”,
  “password” );
  conn = (WebDAVConnection) connectionFactory.getConnection
  ( spec );
```

For a standalone client, the sample code for creating a connection to a WebDAV server is very similar:

ManagedConnectionFactory mcFactory;
ConnectionSpec spec;
ConnectionFactory factory
WebDAVConnection connection;
mcFactory = WebDAVManagedConnectionFactory ( );
factory = mcFactory.createConnectionFactory ( );
spec = new WebDAVConnectionSpec ( “/”, “username”,
“password” );
connection = (WebDAVConnection) factory.getConnection ( spec );

The following sample code shows how to invoke a WebDAV request by simulating a directory listing by asking for the WebDAV properties resourcetype and displayname.

PropertyInteractionSpec pfSpec;
RecordFactory recordFactory;
IndexRecord i r;
Interaction interaction;
MultiStatusResponseRecord msr;
pfSpec = new PropertyInteractionSpec ( );
pfSpec.setFunctionName (“PROPFIND”);
pfSpec.setQueryType (PropertyInteractionSpec.QUERY_{—}
NAMEVALUE);
pfSpec.setPath (browseur 1);
// Note that the depth is 1 to retrieve the children of the resource,
// which will produce the directory listing.
pfSpec.setDepth (1);
recordFactory = connectionFactory.getRecordFactory ( );
i r = recordFactory.createIndexRecord ( “property-request” );
i r .add(new WebDAVProperty ( “DAV:”, “resourcetype”));
i r .add(new WebDAVProperty ( “DAV:”, “displayname”));
interaction = conn.createInteraction ( );
msr = (MultiStatusResponseRecord) interaction.execute
( pfSpec, i r );

The following sample code illustrates how to read a WebDAV response by looping through the results of the above query.

```
// Useful constants for producing directory listings
WebDAVProperty resourcetype = new WebDAVProperty ( “DAV:”,
“resourcetype” );
WebDAVProperty collectiontype = new WebDAVProperty ( “DAV:”,
“collection”);
// The resource to request a directory listing of.
String the ResourceUrl;
// Initialized above
Multi StatusResponseRecord msr;
Iterator msr Itor;
PropertiesRecord pr;
msr Itor = msr .keySet ( ) .iterator ( );
while (msf Itor .hasNext ( ))
{
  String href = (String) msr Itor.next ( );
  if ( href.equals ( the RequestorUrl ))
  {
    // Skip the requested resource, or, in directory terms
    continue;
  }
  pr = (PropertiesRecord) msr .get ( href );
  if(pr != null)
  {
  List rtValue = (List pr.get (resourcetype);
    List displaynames = (List) pr.get (displayname);
    Iterator itor;
    resourcetype = (List) pr.get ( resourcetype );
    if (displaynames) != null && displaynames.size ( ) > 0)
    {
      System.out.print (displaynames.get ( 0 ));
      }
      else
      {System.out.print ( href );
      }
    if (rtValue != null && rtValue.size ( ) > 0
      && reValue.get(0).equals ( collectiontype ))
    {
      // The resource is a collection. Print the directory marker.
      System.out.print ( “/” );
    }
    System.out.println ( );
  }
}
```

What is claimed is:

1. A system operable to support Web-based Distributed Authoring and Versioning (WebDAV) protocol, said system comprising:
a plurality of applications and server implementations; and
a WebDAV unit testing framework operable to facilitate unit testing of said applications and said server implementations for compliance with WebDAV protocol;
wherein said WebDAV unit testing framework is operable to allow said servers to be tested for compliance with said WebDAV protocol via a simple Application Programming Interface (API).

2. The system of claim 1 further comprising a WebDAV compliance utility operable to provide a performance suite of unit tests for measuring performance of said applications and said server implementations during operation within a WebDAV protocol environment via said WebDAV unit testing framework.

3. The system of claim 1 wherein said WebDAV unit testing framework is operable to allow automated testing of said applications and said server implementations within a WebDAV protocol environment.

4. The system of claim 1 wherein said WebDAV unit testing framework further comprises a first object operable to contain the context for a series of WebDAV requests.

5. The system of claim 4 wherein said first object is operable to compute relative URLs.

6. The system of claim 4 wherein said first object is operable to emulate client behavior needed to perform an automated test of said server implementations in said WebDAV protocol environment.

7. The system of claim 1 wherein said WebDAV unit testing framework further comprises a first class operable to hold the contents of said WebDAV request;

8. The system of claim 7 wherein said contents are selected from the group consisting of WebDAV method, header information, and body of request.

9. The system of claim 1 wherein said WebDAV unit testing framework further comprises a second class operable to represent a response of a standard HTTP request and/or WebDAV request.

10. The system of claim 9 wherein said second class contains response headers and response data.

11. A method of unit testing of a component selected from the group consisting of applications and server implementations for response relative to the WebDAV protocol, said method comprising:
providing a WebDAV unit testing framework;
providing a WebDAV compliance utility containing a suite of unit tests;
applying a unit test from said suite to said component under test via said unit-testing framework; and
comparing the response of said component to said applied unit test with a standard unit test response stored in memory.

12. The method of claim 11 wherein said unit test is applied via a simple Application Programming Interface (API).

13. The method of claim 11 wherein said testing is automated.

14. The method of claim 11 further comprising storing the context for a series of WebDAV requests in said WebDAV unit testing framework.

15. The method of claim 11 further comprising storing and managing cookies used to maintain session context.

16. The method of claim 11 further comprising computing relative URLs.

17. The method of claim 11 wherein said WebDAV unit testing framework emulates client behavior needed to implement an automated WebDAV unit test of said component.

18. The method of claim 11 further comprising storing contents of a WebDAV request in said WebDAV unit testing framework.

19. The method of claim 11 further comprising storing data representing said standard unit test response in said WebDAV unit testing framework.

20. The method of claim 11 wherein said applied unit test measures a capability of said component selected from the group consisting of compliance of said component with said WebDAV protocol and specific performance of said component during operation within a WebDAV protocol environment.

21. A system operable to support Web-based Distributed Authoring and Versioning (WebDAV) protocol, said system comprising:
means for providing a WebDAV unit testing framework;
means for providing a WebDAV compliance utility containing a suite of unit tests;
means for applying a unit test from said suite to said component under test via said unit-testing framework; and
means for comparing the response of said component to said applied unit test with a standard unit test response stored in memory.

22. The system of claim 21 further comprising means for applying said unit test via a simple Application Programming Interface (API).

23. The system of claim 21 further comprising means for automating said testing.

24. The system of claim 21 further comprising means for storing the context for a series of WebDAV requests in said WebDAV unit testing framework.

25. The system of claim 21 further comprising means for storing and managing cookies used to maintain session context.

26. The system of claim 21 further comprising means for computing relative URLs.

27. The system of claim 21 wherein said WebDAV unit testing framework comprises means for emulating client behavior needed to implement an automated WebDAV unit test of said component.

28. The system of claim 21 further comprising means for storing contents of a WebDAV request in said WebDAV unit testing framework.

29. The system of claim 21 further comprising means for storing data representing said standard unit test response in said WebDAV unit testing framework.

30. The system of claim 21 further comprising means for said applied unit test to measure a capability of said component selected from the group consisting of compliance of said component with said WebDAV protocol and specific performance of said component during operation within a WebDAV protocol environment.

31. Computer-executable software code stored to a computer-readable medium, said computer-executable software code comprising:
code for applying a unit test from a suite to a component under test via a unit-testing framework; and
code for comparing the response of said component to said applied unit test with a standard unit test response stored in memory.

32. The computer-executable software code of claim 31 further comprising code for applying said unit test via a simple Application Programming Interface (API).

33. The computer-executable software code of claim 31 further comprising code for storing the context for a series of WebDAV requests in said WebDAV unit testing framework.

34. The computer-executable software code of claim 31 further comprising code for computing relative URLs.

35. The computer-executable software code of claim 31 further comprising code for emulating client behavior needed to implement an automated WebDAV unit test of said component.
